(19) United States
(12) Patent Application Publication
(10) Pub. No.: US 2011/0059224 A1
(43) Pub. Date: Mar. 10, 2011

(54) COFFEE FLAVORED CHOCOLATE BAR

(76) Inventor: P. Craig Harrison, Lancaster, PA (US)

(21) Appl. No.: 12/555,002

(22) Filed: Sep. 8, 2009

(51) Int. Cl. A23G 1/32; A23G 1/50

(52) U.S. Cl. 426/631

(57) ABSTRACT

A chocolate candy bar product having a coffee flavor. This is achieved by blending coffee flavored powder or liquid with a chocolate mixture before it is shaped into a candy bar.

### BACKGROUND OF THE INVENTION

1. Field of the Invention

The present invention relates generally to a candy bar and, more particularly, to a liquid compound containing suspended chocolate solids that are blended with fine particles of a dry powdered coffee or coffee substitute to provide a chocolate candy bar having a coffee flavor.

2. Description of Related Art

A chocolate bar is a popular candy which has a taste and mouth feel that is both distinctive and desired by many people. The principal ingredient in a chocolate bar that contributes to its popularity is cocoa butter.

As with a chocolate candy bar, coffee has a very distinctive taste and is desired by many people as evidenced by the large amount of coffee that is consumed each year.

In one aspect, the present invention is directed to a chocolate candy bar that retains its taste and mouth feel and also has the distinctive taste characteristics of coffee.

### SUMMARY OF THE INVENTION

In an exemplary embodiment of the present invention, there is disclosed a chocolate candy bar product having a coffee flavor wherein a real, artificial or imitation coffee extract or coffee powder is blended into a liquid compound containing real, artificial or imitation suspended chocolate solids prior to it being molded to provide a chocolate candy bar having a coffee flavor.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

Other aspects, features, and advantages of the present invention will become more fully apparent from the following detailed description and the appended claims.

### DESCRIPTION OF THE PREFERRED EMBODIMENT

The invention disclosed is directed toward adding the flavor of coffee to a chocolate bar. The chocolate for the chocolate bar can be made using the ingredients and method disclosed by any one of the various prior art methods for making chocolate. One such method of preparing chocolate for a chocolate candy bar is disclosed in U.S. Pat. No. 4,224,354 by Szegvari which is incorporated herein by reference in its entirety. Portions of Szegvan are reproduced below for the convenience of the reader, it being understood, however, that this invention is not limited to any specific method of preparing chocolate.

Chocolate is made by pulverizing and mixing various types of chocolate solids in a liquid compound. After a sifting process, the nib is ground to produce a cocoa mass or chocolate liquor (sometimes called “bitter chocolate”), from which cocoa butter can be removed by pressing. The removed cocoa butter is used in the preparation of chocolate by adding it into a mixture of sugar and nib and/or chocolate liquor to produce sweet chocolate which is also referred to as “plain chocolate”, and into a mixture of sugar, milk powder and nib and/or chocolate liquor to produce milk chocolate.

Chocolate solids are ground in a liquid compound by repeatedly circulating by a pump means the liquid containing chocolate solids through a pulverizing means formed of a bed of agitated grinding elements in a confining vessel. The circulation proceeds at a rate of at least about 30 and preferably between 50 and 500 volumes of the liquid compound containing solids in the pulverizing means per hour. That is to say, at least 30 volumes of the liquid dispersion capacity of the confining vessel is circulated through the pulverizing means per hour. In this connection, it should be noted that the liquid dispersion capacity of the confining vessel is preferably about 35 to 50 percent of the total volume of the vessel. The remainder of the total volume of the confining vessel is taken up by the grinding elements and agitator. In any case, the grinding elements must be sufficient and restricted to provide for efficient grinding and dynamic sieve action.

In some embodiments, the liquid containing chocolate solids may be circulated directly between the pump means and the pulverizing means with the major portion of the liquid compound in the system in the pulverizing means, with the excess in the outlet or retaining chamber from the pulverizing means, the pump means, and the conducting means between the pump and pulverizing means.

In chocolate processing, it is preferred, however, to circulate the liquid compound containing chocolate solids from and through a retaining or storage tank(s) or chamber(s) as well as the pulverizing and pump means. In such embodiments, the retaining tank or chamber may take on different sizes and shapes and are integral with or separate from the pulverizing means and/or pump means. When integral with the pulverizing means, a jacketed vessel may be provided with the retaining chamber or portion in the jacket space between the inner and outer vessels and the pulverizing means in the inner pulverizing vessel, or the retaining tank or chamber and pulverizing means may be in one vessel separated by a simple retaining screen or the like. In any case, the total volume of the pulverizing means is preferably several times less than the volume of the retaining chamber, but in other instances may be the same volume or less than the dispersion capacity of the pulverizing means.

The method of grinding consists of first providing a liquid compound of real, artificial or imitation chocolate or chocolate flavored material to be ground and suspended in a pumpable mass typically by heating and mixing the liquid compound in a jacketed retaining chamber through which steam is circulated. In making sweet chocolate, milk chocolate, and chocolate flavored materials, the liquid compound is directly provided by melting chocolate liquor and by liquid vegetable fats that can provide the liquid phase. Where chocolate liquor is produced from nibs, the formation of the liquid compound is typically provided by impact milling with a hammer mill or the like. Similarly, the compound of chocolate flavored compositions requires the use of a separate liquid compound, such as vegetable fats, in which the cocoa powder can be suspended.

Whatever the specific grind, the liquid compound containing suspended chocolate solids is circulated from a pump means through the pulverizing means formed of a bed of agitated grinding elements at a rate of at least about 30 volumes and preferably between 50 and 500 volumes of liquid compound containing solids in the pulverizing means per hour. The suspended chocolate solids are pulverized in the pulverizing means as they pass with the liquid compound through and are discharged from the pulverizing means with the liquid media at the same rate at an end portion substantially opposite from the point of circulation to the pulverizing means. On discharge, the suspended chocolate solids with the liquid compound are recycled to the pump means, or to a first or second retaining chamber, from where the chocolate solids with the liquid compound are recycled back to the pulverizing means.

The liquid compound is recycled between the pump means, possibly one or more retaining chambers, and the pulverizing means until the chocolate solids in the liquid compound are reduced to the desired particle size and added ingredients such as sugar and milk are uniformly ground and homogeneously dispersed through the chocolate particles and liquid compound. Chocolate solids, chocolate solid-liquids, cocoa butter and other ingredients may be added to the liquid compound intermittently or continuously during the pulverizing operation for various reasons. It has been generally recognized by those skilled in the art that a batch once provided is not usually supplemented by materials requiring processing, but rather maintained until the end of the grinding operation when the batch is removed and a new batch is provided. However, new chocolate solids such as nibs, sugar, milk powder and other ingredients can be dispersed in the already formed batch so that chocolate may be added during processing to provide an end product of dispersed chocolate solids of different desired pulverizing times.

The method of making chocolate is preferably performed with an agitated-media pulverizing means. The liquid containing chocolate solids are repeatedly circulated through the bed of agitated grinding elements in a confining vessel at a velocity such that there are at least 30 volumes and preferably many volumes more, even up to and greater than 500 volumes of liquid compound containing solids in the confining vessel per hour. The flow through the agitated-media vessel is preferably in a vertical direction and along the axis of the rotatable agitator within the vessel. To achieve this condition, a pump means is provided for causing repeated flow through the pulverizing means at a rate of at least 30 volumes and preferably of between 50 and 500 volumes of pulverized liquid compound continuing suspended solids in the pulverizing means per hour. Further, a retaining chamber or portion is preferably provided at outlet portions of the pulverizing means separated from the pulverizing vessel by a retaining screen for retaining the grinding element in the pulverizing means while permitting preferably substantially unrestricted passage of the liquid containing particulate solids from the pulverizing means into the retaining chamber. The retaining chamber or portion is believed to aid in the circulation and operation by providing a more uniform flow through the pulverizing means. Further, preferably a pumping means is provided in the retaining chamber to facilitate flow of the generally highly viscous chocolate-liquid compound from the retaining chamber for recirculation.

The flow through the agitated-media pulverizing means is usually generally upwardly or downwardly. Preferably, however, the pulverizing step is accomplished in an agitated-media pulverizing means by passing the liquid compound containing suspended chocolate solids preferably substantially upwardly through a bed of agitated grinding elements from bottom to top portions of the pulverizing means. More preferred, the vertical progress of the liquid compound containing the chocolate solid suspension through the pulverizing means is at least 2 mm per second and preferably at least 5 mm per second.

To the resulting liquid compound containing suspended chocolate solids which can be real, artificial or imitation flavored chocolate, a coffee extract or coffee powder that can be real, artificial or imitation is added. The coffee powder can be roasted ground coffee that is caffeinated, decaffeinated, or it can be liquid, solid or dried versions of coffee extracts or “instant coffee”. The amount of caffeine that is present is between 50 mg to 500 mg per 100 g of the liquid compound containing suspended chocolate solids. The coffee extract or coffee powder can have any desired flavor such as, for example latte, cappuccino, espresso, hazelnut, mocha and the like. The coffee flavor can also be obtained by using an artificial coffee flavoring. The amount of coffee extract or coffee powder as a percentage of liquid compound containing suspended chocolate solids is from 10% to 35%. The percentage of coffee to chocolate should not exceed 33%. It was determined that a percentage of coffee above 33% can result is a chocolate bar that may have a bitter taste. Therefore, the preferred percentage of coffee to chocolate is from 18% to 33%.

The type of coffee bean used and the temperature and length of time that the bean is roasted will affect the flavor of the chocolate candy bar. Regardless of which coffee is used, the particle size should not exceed the particular size of the suspended chocolate solids and the liquid compound containing suspended chocolate solids can be mixed with a fat to produce a paste before being added to the chocolate or added directly to the chocolate.

The liquid compound containing suspended chocolate solids and coffee particles is placed into moulds to form chocolate candy bars. When the bars are removed from the mold they have a distinctive coffee flavor.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A chocolate candy bar product having a coffee flavor.

2. The chocolate candy bar product according to claim 1 wherein a coffee extract or coffee powder is blended into a liquid compound containing suspended chocolate solids prior to it being molded to provide the coffee flavor.

3. The chocolate candy bar product according to claim 2, wherein the coffee extract or coffee powder blended into the liquid compound containing suspended chocolate solids has a flavor that is real, artificial or imitation.

4. The chocolate candy bar product according to claim 2, wherein the coffee extract or coffee powder blended into the liquid compound containing suspended chocolate solids is caffeinated.

5. The chocolate candy bar product according to claim 4, wherein the coffee blended into the liquid compound of suspended chocolate solids can have a particulate size that does not exceed the particulate size of the suspended solids.

6. The chocolate candy bar product according to claim 2, wherein the coffee extract or coffee powder blended into the liquid compound containing suspended chocolate solids is decaffeinated.

7. The chocolate candy bar product according to claim 2, wherein the flavor of the suspended chocolate solids is real, artificial or imitation.

8. The chocolate candy bar product according to claim 2, wherein the coffee powder is ground coffee bean.

9. The chocolate candy bar product according to claim 1, wherein the coffee flavor is from roasted ground coffee that is caffeinated or decaffeinated, or from a liquid, solid or dried coffee extract or an instant coffee.

10. The chocolate candy bar product according to claim 1, wherein the coffee flavor is obtained by artificial coffee flavoring.

11. A process for preparing a chocolate candy bar product of claim 1 comprising: preparing a liquid compound containing suspended chocolate solids; and adding a liquid, solid or instant coffee, coffee extract or coffee powder to said liquid to yield a coffee flavored candy bar.

12. The process according to claim 11, wherein the amount of coffee extract or coffee powder as a percent of liquid compound containing suspended chocolate solids is between 15% to 40%.

13. The process according to claim 12, wherein the amount of coffee extract or coffee powder as a percent of liquid compound containing suspended chocolate solids is between 18% to 33%.

14. The process according to claim 13, wherein the amount coffee extract or coffee powder as a percent of liquid compound containing suspended chocolate solids is about 25% to about 33%.

15. The process according to claim 11 wherein the coffee blended into the liquid compound of suspended chocolate solids can have a particle size that does not exceed the particle size of the suspended chocolate solids.
